(19) United States
(12) Patent Application Publication
(10) Pub. No.: US 2024/0269755 A1
(43) Pub. Date: Aug. 15, 2024

(54) SINGLE-LIP DRILL WITH INTERCHANGEABLE GUIDE BARS FOR SMALL BORE DIAMETERS

(71) Applicant: botek Praezisionsbohrtechnik GmbH, Riederich (DE)

(72) Inventors: Juergen DEEG, Metzingen (DE); Patrick KAMMERER, Nehren (DE); Juergen RUOF, Ohnastetten (DE); Bernd KIRSCHNER, Riederich (DE)

(73) Assignee: botek Praezisionsbohrtechnik GmbH, Riederich (DE)

(21) Appl. No.: 18/442,732

(22) Filed: Feb. 15, 2024

(30) Foreign Application Priority Data
Feb. 15, 2023 (DE) 10 2023 103 626.2

(51) Int. Cl. B23B 51/06

(52) U.S. Cl. CPC B23B 51/066; B23B 2250/12; B23B 2251/201; B23B 2251/56

(57) ABSTRACT

A single-lip drill with interchangeable guide bars is provided, which is particularly suitable for making small bores. Formed in the single-lip drill is a cooling lubricant channel with an enlarged diameter.

This nonprovisional application claims priority under 35 U.S.C. § 119(a) to German Patent Application No. 10 2023 103 626.2, which was filed in Germany on Feb. 15,2023, and which is herein incorporated by reference.

### BACKGROUND OF THE INVENTION

### Field of the Invention

The invention relates to a single-lip drill with interchangeable guide bars with an improved supply of cooling lubricant.

### Description of the Background Art

Single-lip drills with interchangeable guide bars and interchangeable inserts are well known; for example, from DE 27 39 685 C2, DE 25 22 565 A1 or US 2011/0033255 A1.

Interchangeable inserts and interchangeable guide bars have the advantage that only the worn insert or the worn guide bars need to be replaced if necessary. The actual single-lip drill is subject to much less wear and tear than the inserts and guide bars. It can therefore be used for much longer than these. In addition, the single-lip drill can be used to drill various materials, for example by using inserts with appropriately adapted cutting edge geometry.

The insert is inserted into a plate seat and the guide bars are inserted into indentations of the drill head and attached in each case to the drill head with the help of a fastening screw, which is screwed into the corresponding internal threads of the drill head.

In the drill shank and the drill head, a channel for cooling lubricant is provided. Pressurized cooling lubricant is conveyed through this channel from the clamping to the tip of the single-lip drill. This is where the cooling lubricant comes out. It cools the drill edge and lubricates the guide bars. The cooling lubricant flows through a flute back to the clamping of the drill. In this process, the cooling lubricant transports the chips generated by the cutting edge out of the bore. The flute should be as large as possible to ensure smooth chip removal.

It is obvious that as the bore diameter decreases, the space available for the channel and the flute decreases. The aim is to make the cross-section or diameter of the cooling lubricant channel as large as possible so that a large amount of cooling lubricant can be transported through the channel to the tip of the single-lip drill at a relatively low pumping capacity. On the other hand, efforts are also made to make the flute as large as possible in order to ensure trouble-free chip removal. In addition, the remaining tool base body must be sufficiently stable to withstand the static and dynamic loads in the drilling process and to ensure the dimensional accuracy of the bore created.

In the area of the drill head, a plate seat for the interchangeable insert as well as two indentations for the form-fitting mounting of the interchangeable guide bars must be accommodated. There is at least one internal thread in both the plate seat and the indentations. If the drilling process requires longer guide lengths, two guide bars are arranged one behind the other in an indentation. In this case, two internal threads are provided for each indentation or guide bar seat.

There are usually stepped bores in the insert and the guide bars. Screws are inserted through these bores and screwed into the corresponding internal threads in the drill head, so that the insert and guide bars are securely positioned and held in the plate seat or indentations.

The internal threads of the insert mount and the indentations must not touch the channel for the cooling lubricant, otherwise the channel would leak.

US 2011/0008116 A1, US 2011/0033255 A1 and EP 2216115 A1 describe an approach to remedy the “space problem” in the drill head of single-lip drills with a drill diameter of ten to twelve millimeters, for example. The approach is to provide two parallel cooling lubricant channels with a relatively small diameter in the shank of the drill and in the drill head. These cooling lubricant channels flow into a cooling lubricant groove formed on the outside of the drill head (see, for example, reference sign 5 in FIG. 1 of US 2011/0008116 A1). As a result of these measures, a large flow cross-section can also be provided in the area of the drill head.

Firstly, this approach is very expensive to produce because the production of two cooling lubricant channels naturally incurs more costs than the production of one cooling lubricant channel. In addition, the drilling of such bores with a very small diameter can only be carried out comparatively slowly and is also prone to errors. In addition, with the same cross-sectional area, two small cooling lubricant channels have a greater flow resistance than one cooling lubricant channel.

### SUMMARY OF THE INVENTION

It is therefore an object of the invention to provide a single-lip drill with interchangeable guide bars and optionally a interchangeable insert, which is suitable for small bore diameters and allows for an improved supply of the cooling lubricant as compared to the conventional art. In addition, the drill should also be inexpensive to manufacture.

This object is achieved, in an example, with a single-lip drill with interchangeable guide bars, comprising a drill head, wherein the drill head has a flute, and a cooling lubricant channel as well as two indentations for the form-fitting mounting of the guide bars, the indentations having two parallel side faces and a base surface, and the cooling lubricant channel opening into a front side of the drill head, in that the width of the base area is at least 30% less than a distance of the side faces of the indentations or that a width of the side faces is at least 30% less than a depth of the indentations.

This means that the indentations do not have a rectangular cross-section. The cross-sections of the indentations according to the invention allow for the required precise positioning and positive connection between the guide bars and the indentations, on the other hand they require less space in the drill head, so that more space remains between the indentations in the drill head of the single-lip drill under otherwise equal conditions. A channel for the cooling lubricant with a correspondingly larger diameter is provided there.

Due to the design of the indentations according to the invention, the cross-section of the cooling lubricant channel can be enlarged by about 40% under all other boundary conditions. As a result, a considerably larger volume flow of the cooling lubricant can be conveyed to the tip of the single-lip drill. This improves the cooling and lubrication of the cutting edge and the guide bars and consequently leads to a longer service life of the cutting edge and the guide bars. In addition, chip removal is improved by the increased volume flow of cooling lubricant and chip settling in the chip channel/in the flute is prevented. This “settling” is a common cause of spontaneous tool breakage during deep drilling. Due to the increased volume flow, process reliability in the drilling process increases.

In addition, the feasible drilling depth of a single-lip drill according to the invention is increased as compared to conventional single-lip drills. The flow resistance of the cooling channel(s) increases with increasing tool length and cooling channel length. In the case of a single-lip drill according to the invention with a large diameter cooling channel, an extension of the tool and consequently also of the cooling channel has a significantly lesser effect than in the case of a single-lip drill with two cooling channels of small diameter.

Furthermore, by using the single-lip drill according to the invention, larger drilling depths and feed rates can be realized on drills whose cooling lubricant supply provides only low pressures and flow rates. In addition, productivity, process reliability and service life increase.

These advantages according to the invention come into play in single-lip drills of all diameters. Common bore diameters are currently in the range of about 10 mm to 45 mm, although the invention is not limited to these diameters.

The invention is particularly advantageous in the case of single-lip drills with small diameters—from about 10 mm, for example. It not only makes it possible to increase the drilling depth of these single-lip drills while at the same time improving process reliability; some applications can only be realized with a single-lip drill according to the invention.

As a rule, the diameter of the cooling lubricant channel for small drill diameters (i.e., from 9.5 mm to 12.5 mm) is about 20% of the drill diameter. It can also be 22% or even 25%.

Further advantages of the single-lip drill according to the invention can be seen in the fact that a channel with a larger diameter is easier to manufacture than a channel with a small diameter. In addition, the volume to be machined when milling out the indentations in the drill head is smaller than with conventional single-lip drills. As a result, in many cases, the processing time for making the indentations can also be reduced.

In addition, the cross-sections of the indentations according to the invention have a lower notching effect than conventional indentations. This has a positive effect on the stability of the drill head and its ability to transmit high torques from the clamping to the insert.

In the case of conventional single-lip drills with indentations, which have a rectangular cross-section with sharp edges at the junction between the side faces and the base area, the notching effect is significant.

It has been shown to be advantageous if at least one flat connecting surface is provided between a lower edge of the side faces and a lateral boundary of the base area.

Advantageously, this connecting surface runs at an angle of about 45° between the base area and the connecting surface. In other words, it bisects the angle between the side faces and the base area of the indentation. As a result, it creates a particularly large amount of space for the cooling lubricant channel and reduces the notching effect of the indentation, which is conducive to the performance of the single-lip drill according to the invention.

Angles between the connecting surface and the base area in a range between 30° and 60° have proven to be beneficial. For these reasons, the angle of 45° is preferable in many cases.

Also, it is possible to provide at least one relief groove between the side faces and the base area. This relief groove, which can be shaped like a stair tread, also reduces the volume of the indentation as compared to a conventional indentation with a rectangular cross-section. In addition, the notching effect is reduced, so that the advantages of the invention are also realized with this cross-section of the indentation.

It is also possible that between a lower edge of the side faces and a lateral boundary of the base area there is at least one single curved connecting surface. This connecting surface can be curved as concave or convex. In both cases, this results in an increase in the cross-sectional area in the drill head, which is available for the cooling lubricant channel. In addition, the notching effect is further reduced by the round transitions, for example if the connecting surface is designed as a radius.

In the case of a concavely curved connecting surface, the notching effect is particularly reduced. In the case of a convex curved connecting surface, the bore diameter of the cooling lubricant channel can be increased particularly strongly.

As usual, the indentations extend in their longitudinal direction more or less parallel to an axis of rotation of the single-lip drill.

A further advantageous design of the invention is that the indentations are not offset from each other by 90° in a circumferential direction, contrary to what is customary in the prior art, but that they are offset from each other by an angle β greater than 90° in the circumferential direction. An angle of 115° has proven to be particularly advantageous. An angular offset in a range between 100° and 118° is particularly advantageous in many cases.

The angle β between the guide bars or the indentations should also not become arbitrarily large, because then the cross-section of the flute should be reduced accordingly.

A particularly advantageous design and further development of the invention provides that a center of the cooling lubricant channel can be arranged in the middle between the connecting surfaces of the two adjacent indentations for the guide bars. This means that the wall thicknesses between the channel and the indentations for the guide bars are the same size on both sides of the channel. This allows for the diameter of the channel to be maximized.

A similar optimization provides for the center of the cooling lubricant channel to be in the middle between a cylindrical outer surface of the drill head and a plate seat of an interchangeable insert of the drill head. This also ensures that the wall thickness between the cooling lubricant channel and the outer diameter of the drill head or between the plate seat of the interchangeable insert is as large as possible and at the same time the weakening of the drill head is minimized.

The flute, which is used to remove the chips, is bordered by a chip surface and a wall. The chip surface and the wall advantageously enclose an angle between 110° and 125°. An angle of 115° is preferred.

The invention also affects the guide bars that are inserted into the indentations of the single-lip drill according to the invention. These guide bars comprise a guide surface, which is usually cylindrical and is located on the outside when the guide bar is mounted, as well as at least two lateral boundary surfaces and at least one support surface, wherein the lateral boundary surfaces extend parallel to each other and wherein the boundary surfaces and the support surface are arranged at right angles to each other, achieved by the fact that a width of the support surface is at least 30% smaller than the distance between the boundary surfaces. In another advantageous design, the width of the boundary surfaces is at least 30% smaller than the thickness of the guide bar.

The guide bars according to the invention can be inserted into the indentations according to the invention and ensure a positive fit between the guide bars and the indentations that is just as good as a conventional indentation and a conventional guide bar with a square cross-section.

The lateral boundary surfaces of the guide bars are accommodated between the parallel side surfaces of the indentation in the drill head free of play or with low play. The support surface of the guide bar is supported on the base area of the indentation, so that an exact positioning and form-fitting connection is created between the indentations and the guide bars.

The tangential forces are introduced between the side faces of the indentation and the lateral boundary surfaces of the guide bars. The radial forces are transmitted from the guide bar via the support surface into the base area, so that a very direct and efficient power transmission is also possible here.

The guide bars can have flat connecting surfaces between the boundary surfaces and the support surface.

The angle between the support surface and the connecting surface can also be between 30°and 60°. Here, too, 45° is preferred.

Alternatively, it is also possible that at least one curved connecting surface is provided between the boundary surfaces and the lateral boundary of the support surface. This connecting surface can be curved as convex or concave.

In any case, the notching effect is reduced and the cross-section available for the cooling lubricant channel in the shank of the drill is increased.

The guide bars can be made of carbide. The drill head can be made of quenched and tempered steel. However, the invention is not limited to this material.

It is advantageous if the guide bar is provided with a hard material coating to reduce wear. The same applies to an interchangeable insert.

In order to place the insert positively and precisely positioned on the drill head, a plate seat at the tip of the drill head is provided accordingly.

The guide surfaces of the guide bars are cylindrical, with the diameter of the cylinder surface being equal to or less than the diameter of the single-lip drill.

In addition to the two guide bars in the drill head, there may be a second group of guide bars arranged axially spaced from the first group of guide bars on the shank 12 of the single-lip drill 1.

Further scope of applicability of the present invention will become apparent from the detailed description given hereinafter. However, it should be understood that the detailed description and specific examples, while indicating preferred embodiments of the invention, are given by way of illustration only, since various changes, combinaitons, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a simplified representation of a single-lip drill without interchangeable parts;

FIG. 2 shows an isometric of an example of a single-lip drill according to the invention;

FIG. 3 shows a view from the front (greatly enlarged) of the example as shown in FIG. 2;

FIG. 4 shows the example as shown in FIG. 2 in two side views;

FIGS. 5 and 6 show the tip of another example of a single-lip drill according to the invention in an isometric;

FIG. 7 shows a view from the front of a second example of a single-lip drill according to the invention; and

FIGS. 8 to 11 show different cross-sectional shapes of indentations and guide bars according to the invention.

### DETAILED DESCRIPTION

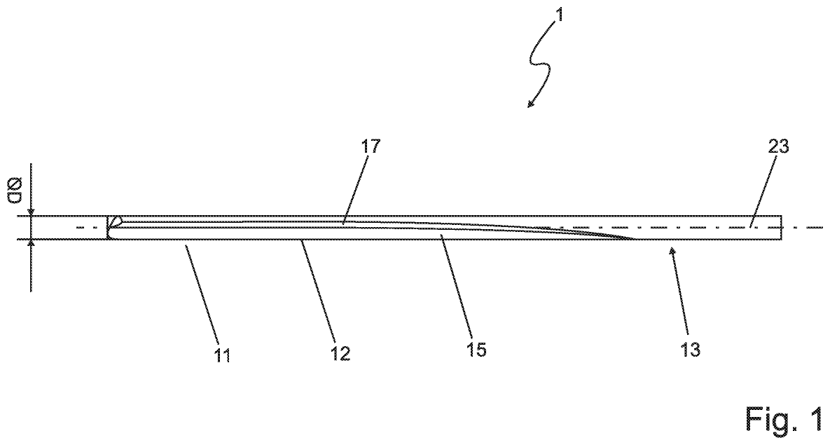

FIG. 1 shows a single-lip drill 1 without interchangeable parts schematically and somewhat simplified. FIG. 1 illustrates some of the terms. The single-lip drill 1 comprises a drill head 11, a profile shank 12 and a clamping 13. The clamping 13 is used to hold the single-lip drill in a deep bore drilling machine.

The drill head 11 according to the invention is usually used for soldered tools. In these cases, the drill head 11, a profile shank 12 and a clamping 13 are soldered together. However, the invention is not limited to this type of tool. Among other things, it can also be used for full-shank tools.

The axis of rotation or the center of the drill head 11 has the reference sign 23. In the drill head 11 and the profile shank 12 a flute 53, which can also be referred to as a chip flute or a single flute, is formed, which is bordered by a chip surface 15 and a wall 17. The single-lip drill 1 according to the invention can have a diameter D of, for example, ten millimeters. As a result, the cross-section of the drill head 11 and the flute 53 is limited.

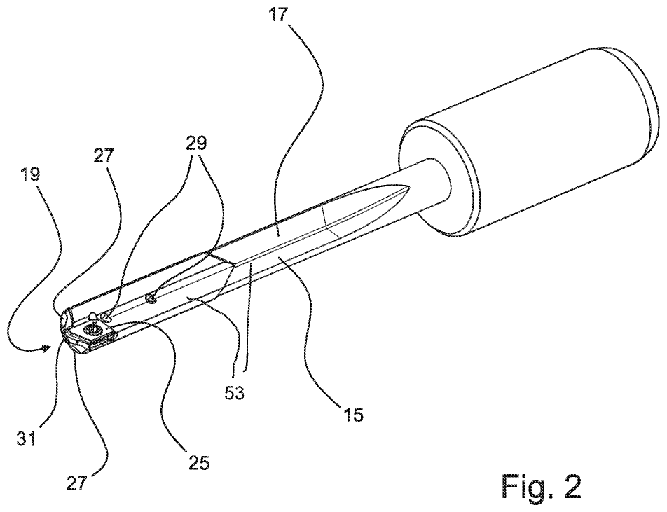

FIG. 2 shows an isometric of an example of a single-lip drill according to the invention with interchangeable parts.

A tip is marked with the reference sign 19. In FIG. 2, an interchangeable insert 25 is clearly visible. Of the guide bars 27, only the front ends are visible in this illustration. In the flute 53, there are two internal threads 29, which are used to fasten one of the two guide bars 27 as well as a guide bar stop.

An outlet 31 of the cooling lubricant channel at the tip 19 of the drill head 11 is also visible in FIG. 2.

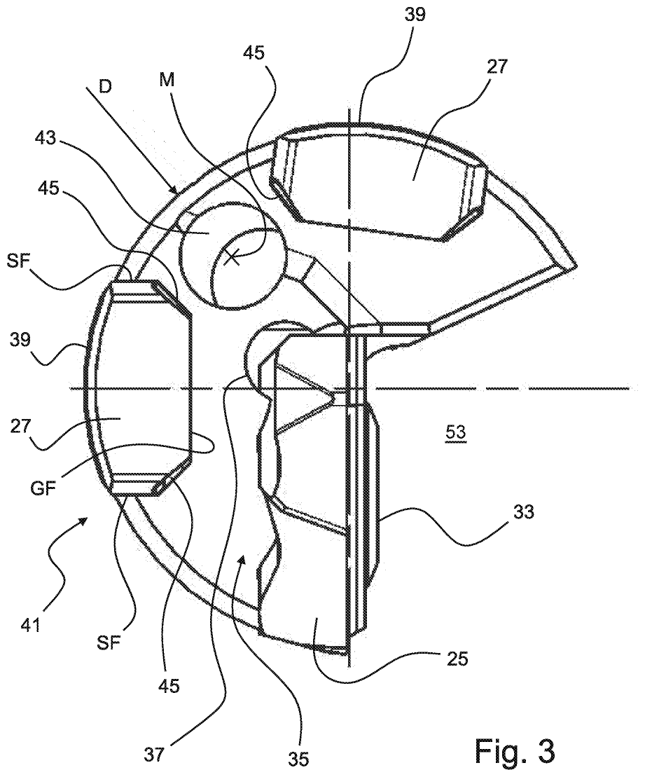

FIG. 3 shows a view from the front, i.e., of the tip 19 of the single-lip drill. FIG. 3 shows the inserted insert 25 and the screw head 33, which is used to fasten the insert 25. The insert 25 is mounted in a plate seat 35 of the drill head 11. Details of the plate seat are not explained in connection with this invention. However, two points may be made in this regard:

At the transition between two surfaces of the plate seat 35, a relief groove 37 is provided. It is part of the plate seat 35.

The “base area” of the plate seat 35 and the underside of the insert 25 are not flat in the example shown but have several grooves that cause a positive fit between the insert 25 and the plate seat 35. The invention is not limited to single-lip drills with plate seats 35 designed in such a way.

In FIG. 3, the guide bars 27 are clearly visible. They include a curved guide surface 39. The curvature of the guide surface 39 is approximately the same as the diameter of the bore made with the single-lip drill 1.

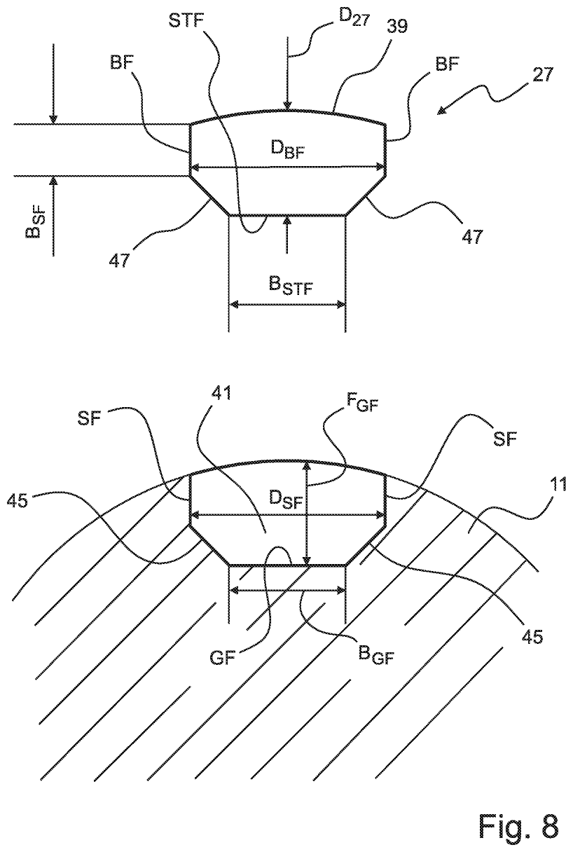

The guide bars 27 are held in indentations 41, which have two parallel side faces SF and a base area GF. The geometrical details of the guide bars 39 and the indentation 41 are illustrated and explained using FIGS. 8 to 11.

It can be clearly seen in FIG. 3 that in this example, the indentations 41 between the side faces SF and the base area GF have a flat connecting surface 45. In FIG. 3, this flat connecting surface 45 runs at an angle of about 45° to the base area GF. In this example, it represents the bisecting angle between the base area GF and the side faces SF.

In FIG. 3, the outlet of the channel 43 at the front or tip 19 of the single-lip drill is clearly visible. The channel 43 has a circular cross-section. The flat connecting surfaces, which are designed as bisecting angles, create more space in the shank of the single-lip drill for the channel 43. In other words, the diameter of the channel 43 can be significantly increased as compared to conventional single-lip drills, whose indentations have a rectangular cross-section.

Furthermore, it is easy to see that the center M of the channel 43 is located in the middle between the connecting surfaces 45 of the two indentations 41 and in the middle between an outer diameter D and the plate seat 35 for the insert 25.

In the present case, the distance between the center M of the channel 43 and the undercut 37, which is also part of the plate seat 35, is decisive. The undercut 37 has the shortest distance to the channel 43. Therefore, this distance is decisive for the arrangement of the center M of the channel 43.

In this way, the cross-sectional area of the drill head 11 between the indentations 41, the outer diameter D and the plate seat 35 or the relief groove 37 is optimally utilized in order to accommodate a cooling lubricant channel 43 with the largest possible diameter with a simultaneously stable tool base body or drill head.

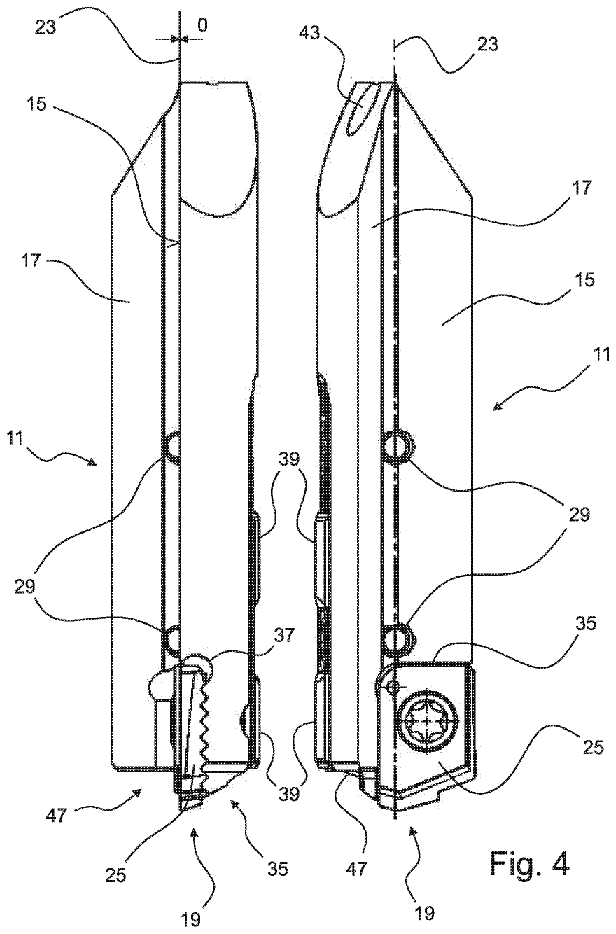

FIG. 4 shows two side views of the single-lip drill according to the invention, which can be used to explain the design of the drill tip 19 and the plate seat 35 in more detail.

FIG. 4 shows the guide bars 27, which extend parallel to the axis of rotation 23. The guide surfaces 39 are interrupted where the step bores for the fastening screws are provided. This ensures that the screw head does not come into contact with the bore, but that only the guide surfaces 39 are in contact with the bore wall.

In the area of the tip 19, the drill head 11 has an indentation 47. The cooling lubricant channel 43 ends in or leads to the indentation 47. The indentation 47, on the other hand, is designed in such a way that the cooling lubricant escaping from the channel can reach the chip surface and the cutting edges of the insert 25 directly. This results in optimum cooling and chip removal. The invention is not limited to this particularly advantageous design of the tip.

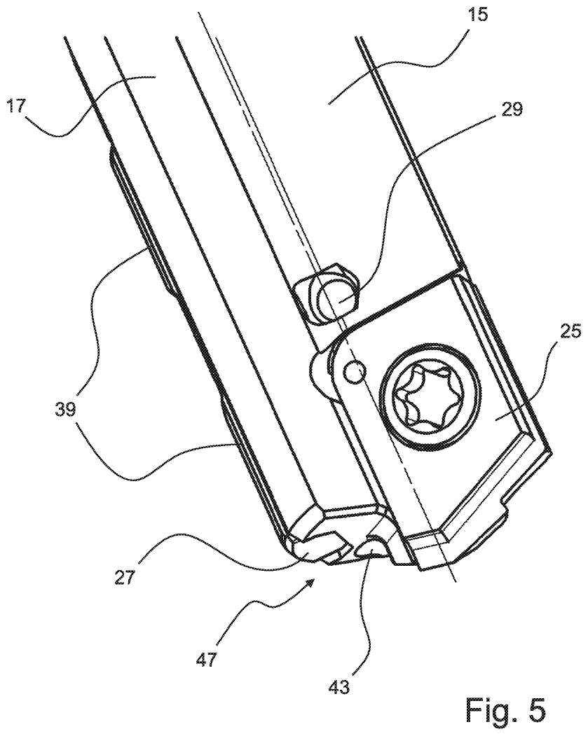

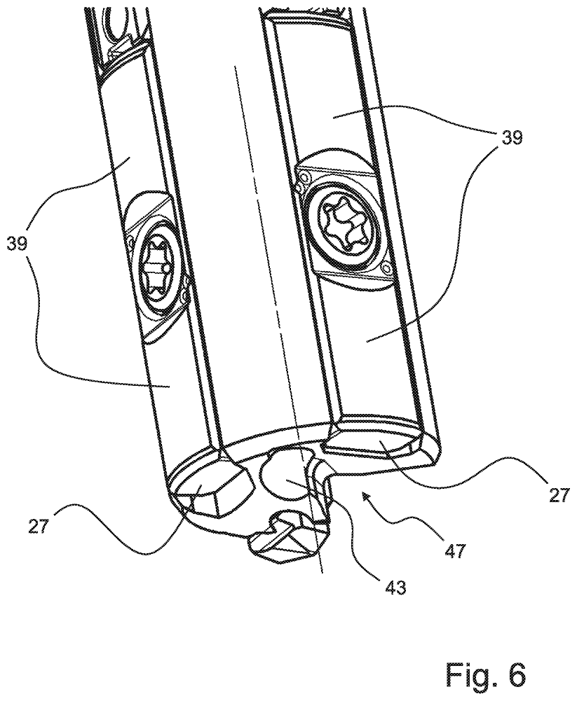

The geometry of the indentation 47 is also clearly visible in FIGS. 5 and 6.

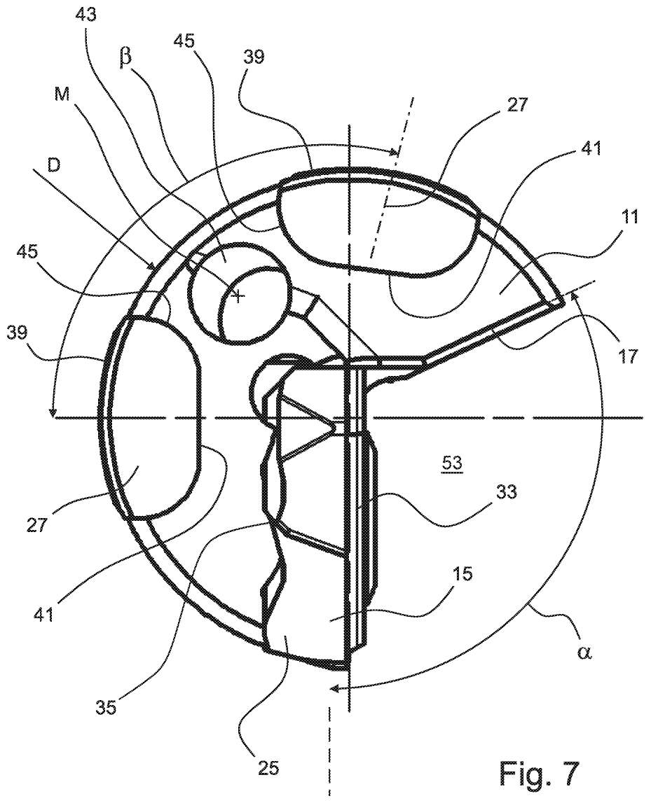

FIG. 7 shows a view from the front of an example of a single-lip drill 1 according to the invention. In this example, the connecting surfaces between the side faces SF and the base area GF of the indentations 41 are designed as simple curved concave surfaces. This also significantly increases the installation space in the drill head 11 between the indentations 41. The advantage of this design is the further reduced notching effect due to the “soft” transition between the side faces SF and the base area GF.

In FIG. 7 it is also easy to see that an angle β around which the indentations 41 are offset in the circumferential direction is greater than 90°. For example, the angle β can be 115°. It is very advantageous if it is smaller than 118°.

The fact that the angle β is greater than 90° creates more space between the connecting surfaces 45 of the indentations 41, which benefits the diameter of the cooling lubricant channel 43.

Ultimately, the angle β can be chosen such that the distance between the center M of the cooling lubricant channel 43 to the plate seat 35 or its relief groove 37 and to the diameter D of the drill is the same as the distance between the center M and the connecting surfaces 45 of the indentations 41. These distances have already been explained in FIG. 3. On the one hand, this makes optimum use of the installation space/cross-sectional area between the indentations 41 and, on the other hand, the angle β is limited to the necessary extent, so that the indentations 41 are not further apart from each other than necessary. A larger angle β ultimately leads to the need to reduce the angle α at some point, which usually does not provide any benefits.

“α” refers to the angle between the chip surface 15 and the wall 17. They limit the flute 53 of the single-lip drill. The angle “α” is approximately equal to 115° in this example. The greater the angle α, the more volume is available in the flute 53 for the removal of chips or cooling lubricant. Therefore, a large angle α is always desirable.

On the basis of FIGS. 8 to 11, further cross-sections of the indentations 41 and the corresponding cross-sections of the guide bars 27 are shown. In this case, the guide bar 27 is not inserted into the indentation 41. The thread and the bore for the fastening screws are also not shown.

FIG. 8 shows an example of an indentation 41 of an example of a single-lip drill and a guide bar 27. In this example, the connecting surface 45 between the side faces SF and the base area GF of the indentation 41 is designed as a flat connecting surface 47. It has an angle of 45° to the base area GF and the side faces SF. This means that it is designed as a bisecting angle.

In the same way, a flat connecting surface 47 is formed between the boundary surfaces BF and the support surface STF of the guide bar 27.

Thus, it is possible to insert the guide bar 27 into the indentation 41, so that the lateral forces, i.e., the forces in the circumferential direction, are transmitted between the boundary surfaces BF and the side faces SF. The forces acting in the radial direction are transmitted to the base area GF via the support surface STF of the connecting surface 45.

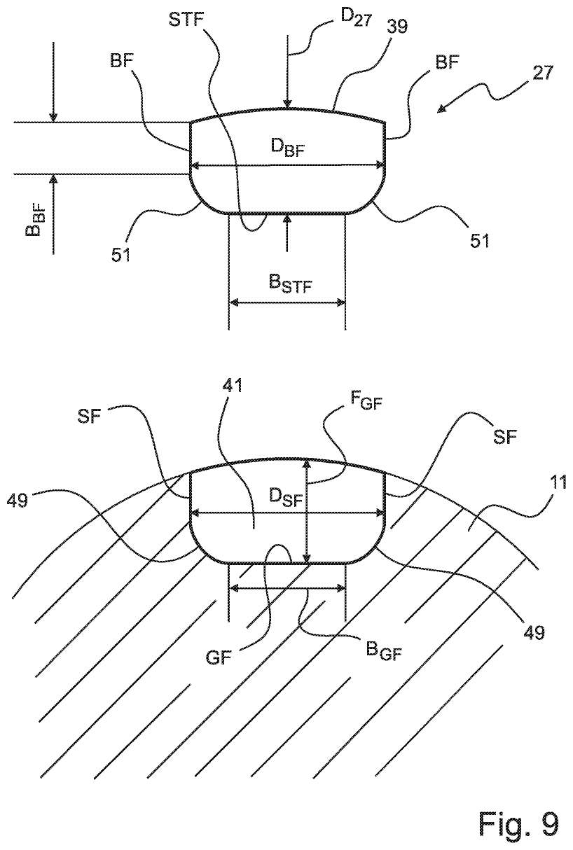

FIG. 9 shows an example in which the connecting surfaces 49 and 51 are designed as curved surfaces.

The connecting surfaces of the indentation 49 are designed as simple curved concave surfaces.

The connecting surfaces 51 of the guide bar 27 are designed as simple curved convex surfaces.

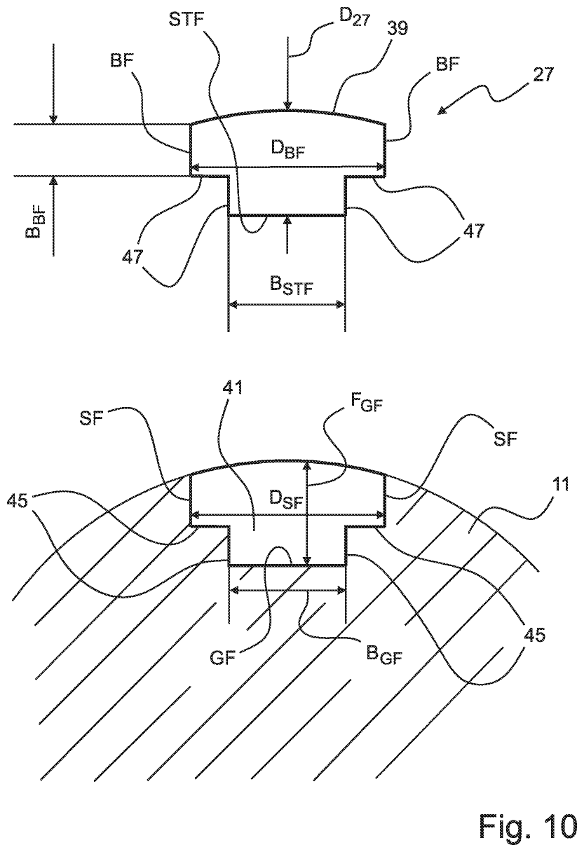

FIG. 10 shows an example in which the transition/connection between the side faces SF and the base area GF is created with the help of two flat (non-curved) connecting surfaces 45 in the indentation 41.

Correspondingly, the guide bar 27 also has several flat connecting surfaces 47 at the transition between the boundary surfaces BF and the support surface STF.

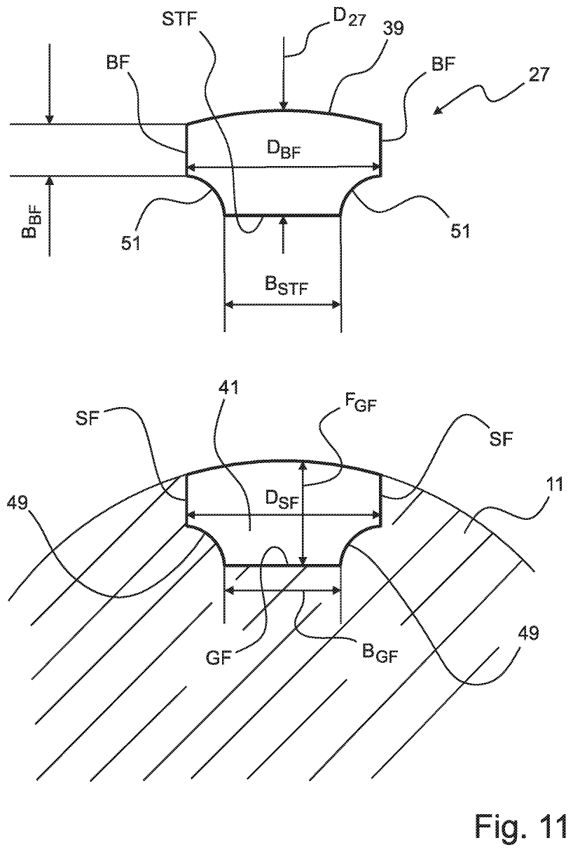

FIG. 11 shows an example in which the curved connecting surfaces 49 and 51 are convex at the indentation and correspondingly concavely curved at the guide bar 27. This example provides a particularly large amount of additional installation space in the drill head 1 for the channel 43.

The cross-sections of the guide bars 27 according to the invention and the cross-sections of the indentations according to the invention need not be geometrically similar. For example, the guide bars 27 shown in FIG. 8, FIG. 10 and FIG. 11 can be inserted into the indentation 41 shown in FIG. 9. It is also possible to insert the guide bar 27 shown in FIG. 10 into the indentation 41 shown in FIG. 11. The prerequisite is that the support surface STF of the guide bar 27 rests on the base area GF of the indentation 41, and that the width D_{BF} of the guide bar 27 is matched to the width D_{SF} of the indentation 41.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A single-lip drill comprising:
a drill head that comprises two interchangeable guide bars, a flute, and a cooling lubricant channel; and
two indentations formed in the drill head to mount the two interchangeable guide bars, the two indentations having two substantially parallel side faces and a base area,
wherein the cooling lubricant channel ends in a front side or tip of the drill head, and
wherein a width of the base area is at least 30% smaller than a distance of the side faces.

2. A single-lip drill comprising:
a drill head;
two interchangeable guide bars;
a flute;
a cooling lubricant channel; and
two indentations arranged in the drill head for mounting the two interchangeable guide bars, the two indentations having two substantially parallel side faces and a base area,
wherein the cooling lubricant channel ends in a tip of the drill head, and
wherein a width of the side faces is at least 30% smaller than a depth of the indentation.

3. The single-lip drill according to claim 1, wherein at least one flat connecting surface is provided between a side surface and the base area.

4. The single-lip drill according to claim 3, wherein at least one relief groove is provided between the side faces and the base area.

5. The single-lip drill according to claim 1, wherein at least a single curved connecting surface is provided between a side surface and the base area.

6. The single-lip drill according to claim 5, wherein the curved connecting surface is curved as concave or convex.

7. The single-lip drill according to claim 1, wherein the indentations extend substantially parallel to an axis of rotation of the single-lip drill.

8. The single-lip drill according to claim 1, wherein the indentations are offset from each other in a circumferential direction by an angle β greater than 100° and less than 118°.

9. The single-lip drill according to claim 3, wherein a center of the cooling lubricant channel lies in the middle between the flat connecting surfaces or in the middle between the at least single-curved connecting surfaces of the indentations.

10. The single-lip drill according to claim 1, wherein a center of the cooling lubricant channel lies in a middle between a cylindrical outer surface of the drill head and a plate seat of an interchangeable insert of the drill head.

11. The single-lip drill according to claim 1, wherein the flute is delimited by a chip surface and a wall, wherein the chip surface and the wall enclose an angle, and wherein the angle is between 105° and 125°, or is equal to 115°.

12. A guide bar for a single-lip drill, the guide bar comprising:
a guide surface;
two lateral boundary surfaces; and
at least one support surface,
wherein the lateral boundary surfaces are substantially parallel to each other,
wherein the lateral boundary surfaces and the support surface are arranged at right angles to each other,
wherein a width of the support surface is at least 30% smaller than a distance of the boundary surfaces or a width of the boundary surfaces is at least 30% smaller than a thickness of the guide bar.

13. The guide bar according to claim 12, wherein at least one flat connecting surface is provided between the boundary surfaces and the support surface.

14. The guide bar according to claim 12, wherein at least one shoulder is provided between the boundary surfaces and the support surface.

15. The guide bar according to claim 12, wherein at least one curved connecting surface is provided between the boundary surfaces and the support surface.

16. The guide bar according to claim 12, wherein the guide bar is made of tungsten carbide.

17. The guide bar according to claim 12, wherein the guide bar is provided with a hard material coating.
